(19) United States
(12) Patent Application Publication
(10) Pub. No.: US 2018/0314559 A1
(43) Pub. Date: Nov. 1, 2018

(54) MANAGING LOCK LEASES TO AN EXTERNAL RESOURCE

(71) Applicant: Microsoft Technology Licensing, LLC, Redmond, WA (US)

(72) Inventors: Karthik Gurumoorthy Subramanya Bharathy, Redmond, WA (US); Abdelmoumen Bouabdallah, Redmond, WA (US); David Nissimoff, Bellevue, WA (US)

(73) Assignee: Microsoft Technology Licensing, LLC, Redmond, WA (US)

(21) Appl. No.: 15/853,394

(22) Filed: Dec. 22, 2017

Related U.S. Application Data
(60) Provisional application No. 62/491,205, filed on Apr. 27, 2017.

(51) Int. Cl. G06F 9/50; G06F 17/30

(52) U.S. Cl. CPC G06F 9/5011; G06F 17/30362; G06F 12/0815; G06F 17/30578; G06F 2209/522

(57) ABSTRACT

According to examples, an apparatus may include a processor and a memory on which is stored machine readable instructions that are to cause the processor to store a copy of an external resource on the apparatus, transmit a request for renewal of a lock lease for the external resource, and based on a failure to receive a reply to the renewal request, enter the apparatus into a state in which: the processor processes a new operation on the stored copy of the external resource, and following a determination that the lock lease is lost, the processor outputs a notification that the apparatus lost the lock lease.

### CLAIM FOR PRIORITY

The present application claims the benefit of priority to U.S. Provisional Application Ser. No. 62/491,205 having the title “MANAGING LOCK LEASES TO A NETWORK RESOURCE,” filed on Apr. 27, 2017, the disclosure of which is hereby incorporated by reference in its entirety.

### BACKGROUND

In client-server environments, multiple clients often collaborate with each other in creating and editing network resources, such as files, applications, data, or the like, that a server owns and manages. The clients often store or cache data pertaining to the network resources locally, in which the clients make changes to the locally stored or cached data. Accessing and modifying data locally is more efficient and reduces the burden upon the server so that the server may handle a greater number of requests. Local access to the data also typically improves the response time of network resources, such as applications, because the network resources do not need to wait for the client to send data across a network to the server upon every request.

### BRIEF DESCRIPTION OF THE DRAWINGS

Features of the present disclosure are illustrated by way of example and not limited in the following figure(s), in which like numerals indicate like elements, in which:

FIG. 1 depicts a block diagram of a network environment within which various features of an apparatus, e.g., a client machine, may be implemented in accordance with an embodiment of the present disclosure;

FIG. 2 shows a diagram of an apparatus state machine, in accordance with an embodiment an embodiment of the present disclosure;

FIG. 3 shown a process flow diagram for management of a lock lease to an external resource in accordance with an embodiment of the present disclosure;

FIG. 4 shows a flow diagram of a method for managing a lock lease for an external resource in accordance with an embodiment of the present disclosure; and

FIG. 5 show a flow diagram of a method for managing renewal of a lock lease for an external resource on a server in accordance with an embodiment of the present disclosure.

### DETAILED DESCRIPTION

For simplicity and illustrative purposes, the present disclosure is described by referring mainly to embodiments. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure.

Throughout the present disclosure, the terms “a” and “an” are intended to denote at least one of a particular element. As used herein, the term “includes” means includes but not limited to, the term “including” means including but not limited to. The term “based on” means based at least in part on.

One consideration with providing collaborative access to external resources (equivalently, network resources) is to ensure that multiple client machines do not perform conflicting actions on the external resources. For instance, two clients may update locally stored versions of an external resource prior to either version being saved at the server and thus, a conflict may occur when the versions of the external resource are saved at the server. A mechanism for preventing this type of conflict among multiple clients is to grant a lock lease to the external resource to one client at a time, in which the client with the granted lock lease is granted with exclusive edit control of the external resource. The lock lease is often a time-bound lease to the lock of the external resource. That is, the lock lease often has an expiration time following the lock lease being granted to a client and if the client does not renew the lock lease prior to the expiration time, the client loses the lock lease.

Disclosed herein are apparatuses and methods that may minimize the likelihood of conflicts arising when multiple users are working on or editing the same external resource. An external resource may be defined as a file, an application, data, or the like, that a server owns and manages. In a particular example, the external resource may be a PowerApps™ application available from the Microsoft Corporation™. The server may make the external resource available for creation and editing by multiple users on multiple client machines that are connected to the server via one or more networks. Additionally, the external resource may not support co-authoring and thus, each of the users may store or cache a copy of the external resource on a respective client machine to edit the external resource at any given time. Working on a copy of the external resource stored or cached on the client machine may enable edits to the external resource to be made more efficiently than when such edits are made to the external resource at the server and may also reduce the burden on the server.

The methods and apparatuses disclosed herein may minimize the likelihood of conflicts by granting exclusive editing control of an external resource to one of the client machines at a time. The lock lease may be a time-bound lock lease and may thus expire after a predefined period of time, which may be defined in terms of minutes, hours, days, etc. The client machines may have the opportunity to maintain ownership of the lock lease by renewing the lock lease prior to expiration of the predefined period of time. To ensure that the client machine does not lose the lock lease unintentionally, the client machine may set a task, such as a background task, to automatically renew the lock lease at some periodic interval prior to expiration of the lock lease.

There may arise instances in which the lock lease is not renewed automatically at the periodic interval of time. For instance, the lock lease may not be renewed if a network connection between the client machine and the server is unstable, e.g., has failed, has been interrupted, or the like. The lock lease may also not be renewed in time if there is a failure in the client machine, such as an unplugged cable, a failed network interface, a virus on the client machine, or the like. According to embodiments, in the methods and apparatuses disclosed herein, a client machine may maintain a lock lease under unstable network conditions and with reduced user intervention requirements.

Client machines have traditionally been represented as being in one of two states: “Acquired” and “NotAcquired”. A client machine that is in the Acquired state is a client machine that has acquired a lock lease and all the other client machines are in the NotAcquired state. A client machine in the Acquired state may remain in that state so long as the client machine can prove that the client machine is the sole owner of the lock lease, e.g., by renewing the lock lease before the lock lease period expires. If the client machine does not renew the lock lease before the lock lease expires, the client machine may lose the lock lease and may submit another request to acquire the lock lease. Limiting the client machines to these two states may result in unnecessary “noise” as described using the following example:
1) A client machine acquires an exclusive lock lease and enters the “Acquired” state.
2) The client machine is unable to renew the lock (e.g., due to network instability) and loses the lock lease. The client machine is now in the “NotAcquired” state.
3) Network connectivity is re-established and client machine can re-acquire the lock lease.

In some systems, events (2) and (3) may cause dialogs to be shown to the user of the client machine, in which the dialogs show information and possibly request input of instructions on how to proceed. Also, in the example described above, there may not have been any other client machines that attempted to acquire the exclusive lock between events (2) and (3). Therefore, in this example, the dialogs that were shown to the user may not have been required, but they were shown because the client machine was unsure if another client machine may have acquired the lock lease (e.g., because of the network instability, in this example). As such, a technical problem associated with conventional methods for managing lock leases over network resources may be that dialogs or notifications may unnecessarily be outputted to users, which may unnecessarily consume system resources of the client machines.

According to embodiments disclosed herein, the client machines may enter a certain state when the client machines are not certain as to whether a lock lease to an external resource will be renewed. The certain state may be termed, a PreviouslyAcquiredButCurrentlyUnknown state. Under this state, client machines may operate under an optimistic assumption that the client machine will be able to reacquire a lost lock lease. That is, for instance, the client machine may not automatically output an notification to a user that a lock lease has been lost when the client machine is not certain as to whether a lock lease has been renewed. Instead, the client machine may output the notification when the client machine has determined that the lock lease has been lost, which may occur after communications between the client machine and the server are restored.

Through implementation of the methods and apparatuses disclosed herein, the number of notifications outputted to users when a client machine is unable to renew a lock lease may be reduced or minimized. As such, a technical solution to the technical problem noted above may be that usage of system resources of the client machines may be reduced as the system resources, such as the processors, in the client machines may output fewer numbers of notifications. Additionally, through implementation of the methods and apparatuses disclosed herein, notifications that contain relevant information for the users may be outputted, which may assist the users in their decision-making with respect to whether to discard the changes that they have made to locally stored copies of the external resource, to save the locally stored copies of the external resource using other names, or to force an overwrite of a latest version of the external resource with the locally stored copy of the external resource.

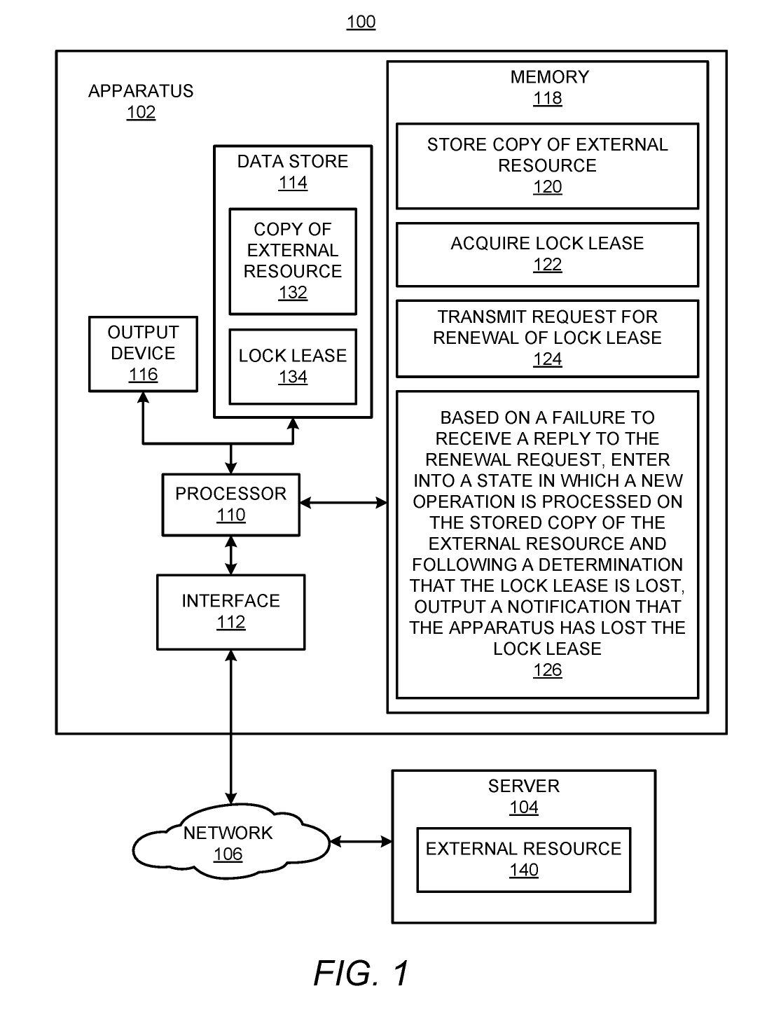

FIG. 1 depicts a block diagram of a network environment 100 within which various features of an apparatus, e.g., a client machine, may be implemented in accordance with an embodiment of the present disclosure. The network environment 100 may include an apparatus 102 in communication with a server 104 via a network 106. The network 106 may be a local area network, a wide area network, the Internet, or the like. Although a single apparatus 102 has been depicted in FIG. 1, it should be understood that multiple apparatuses having similar or different configurations with respect to the apparatus 102 may be included in the network environment 100. Additionally, although a single server 104 has been depicted in FIG. 1, it should be understood that multiple servers having similar or different configurations with respect to the server 104 may be included in the network environment 100.

The apparatus 102 may be a client machine, such as a personal computer, a laptop computer, a tablet computer, a smartphone, or the like. In addition, the apparatus 102 may include a processor 110 that may communicate with the server 104 via an interface 112. The processor 110 may be a semiconductor-based microprocessor, a central processing unit (CPU), an application specific integrated circuit (ASIC), a field-programmable gate array (FPGA), and/or other hardware device. The interface 112 may include hardware, software, or a combination thereof that is to facilitate the communication of information to and from the server 104. Although the apparatus 102 is depicted with a single processor 110, it should be understood that the apparatus 102 may include additional processors 110 without departing from a scope of the apparatus 102.

The apparatus 102 may also include a data store 114, an output device 116, and a memory 118. The data store 114 may be a non-transitory computer readable medium including an electronic, magnetic, optical, or other type of physical storage. The output device 116 may be a speaker, a display, a printer, or the like, on or through which the processor 110 may output notifications to a user. The memory 118 may be, for example, Random Access memory (RAM), an Electrically Erasable Programmable Read-Only Memory (EEPROM), a storage device, an optical disc, and the like. The memory 118, which may also be referred to as a computer readable storage medium, may be a non-transitory machine-readable storage medium, where the term “non-transitory” does not encompass transitory propagating signals. In any regard, the memory 118 may have stored thereon machine readable instructions 120-126. The data store 114 may be similar to any of the devices listed above with respect to the memory 118. In addition, or in other examples, the data store 114 and the memory 118 may be the same device.

The processor 110 may fetch, decode, and execute the instructions 120 to store a copy 132 of an external resource 140 on the apparatus 102. As shown, the external resource 140 may be stored on the server 104 and may be a network resource, e.g., a file, an application, data, or the like. By way of particular examples, the external resource 140 may be a Microsoft PowerApps™ application. The server 104 may own and manage the external resource 140 and may make the external resource 140 available for creation and editing by multiple users on multiple apparatuses (e.g., client machines). The processor 110 may download and store a copy 132 of the external resource 140 in the data store 114 of the apparatus 102 such that the processor 110 may implement user-directed actions, e.g., access, modify, update, or the like, on the copy 132 of the external resource 132. As discussed herein, by acting on the copy 132 of the external resource 140 stored on the apparatus 102 instead of acting on the external resource 140 stored on the server 104, the response time associated with acting on the external resource may be reduced as compared with the response time associated with acting on the external resource 140 saved on the server 104.

The processor 110 may fetch, decode, and execute the instructions 122 to acquire a lock lease 134 on the external resource 140. The processor 110 may store the lock lease 134 or an indication that the apparatus 102 has obtained the lock lease 134 on the external resource 140 in the data store 114. The lock lease 134 may grant the apparatus 102 exclusive edit control of the external resource 140 for a period of time. Particularly, for instance, the lock lease 134 may be a contract between the apparatus 102 (client) and the server 104 in which the server 104 grants the apparatus 102 exclusive edit control of the external resource 140 for a period of time. The server 104 may respect the contract until the period of time expires and/or may extend the contract in response to receipt of extension requests from the apparatus 102. In other words, while the apparatus 102 has been granted the lock lease 134, the server 104 may disregard requests from other apparatuses (e.g., client machines) for exclusive edit control over the external resource 140 and/or may prevent the other apparatuses from being granted the lock lease to the external resource 140.

Once granted to the apparatus 102, the lock lease 134 to the external resource 140 may be active for a predefined period of time, which may be user-defined, defined by an administrator of the server 104, or the like. Prior to expiration of the predefined period of time, the processor 110 may fetch, decode, and execute the instructions 124 to transmit a request for renewal of the lock lease 134. For instance, the processor 110 may set a task, e.g., a background task, to periodically transmit the request for renewal of the lock lease 134 prior to expiration of the predefined time period at which the lock lease 134 expires.

Under normal circumstances, e.g., when the apparatus 102 and the server 104 are operating properly and the connections to the network 106 are operational, the server 104 may receive the request for renewal of the lock lease 134. In addition, the server 104 may send a reply to the apparatus 102 with an indication that the lock lease 134 has been renewed or with an indication that the lock lease 134 has not been renewed. However, when there is an error, such as a network 106 outage, network interruption, or other error, the server 104 may not receive the request for renewal of the lock lease 134 and/or the apparatus 102 may not receive a reply from the server 104. Based on a failure to receive a reply to the renewal request, the processor 110 may fetch, decode, and execute the instructions 126 to enter into a certain state in which the processor 110 processes a new operation on the stored copy 132 of the external resource 140. A new operation may be an operation that a user may initiate and the processor 110 may execute after the apparatus 102 has entered into the certain state. In addition, while in the certain state, the processor 110 may also process an existing operation, e.g., an operation that the processor 110 was already processing and/or had in a queue to be processed prior to the apparatus 102 entering into the certain state. Moreover, while in the certain state and following a determination that the lock lease is lost, the processor 110 may output a notification that the apparatus 102 lost the lock lease 134.

That is, for instance, the processor 110 may determine that the processor 110 has not received a reply to the renewal request from the server 104 within a certain amount of time from when the processor 110 transmitted the request for renewal of the lock lease 134. The certain amount of time may be an amount of time that corresponds to a normal amount of time that elapses between normal communications between the apparatus 102 and the server 104. The certain amount of time may additionally or alternatively correspond to a user-defined time period. In any regard, instead of automatically outputting a notification that the apparatus 102 has lost the lock lease 134, the processor 110 may enter the state discussed herein, e.g., an optimistic state, in which the processor 110 operates under the assumption that the apparatus 102 will re-acquire the lock lease 134.

As discussed herein, while in the optimistic state, the processor 110 may continue to process existing and new operations on the stored copy 132 of the external resource 140. For instance, the processor 110 may continue to process operations such as existing edit and new edit commands on the stored copy 132 of the external resource 140. In addition, the processor 110 may remain in the optimistic state until the processor 110 determines that the apparatus 102 has lost the lock lease 134. The processor 110 may determine that the apparatus 102 has lost the lock lease 134 in response to receipt of a reply from the server 104 that the apparatus 102 has lost the lock lease 134. For instance, while the apparatus 102 was unable to communicate with the server 104, the server 104 may have revoked the lock lease 134. The server 104 may have revoked the lock lease 134, for instance, because the period of time during which the lock lease 134 was to remain in force may have expired prior to the server 104 having received the request for renewal of the lock lease 134. Based on a determination that the apparatus 102 has lost the lock lease 134, the processor 110 may output a notification that the apparatus 102 has lost the lock lease 134.

As discussed above, the output device 116 may be a speaker, a display, a printer, or the like. Thus, for instance, the processor 110 may output the notification that the apparatus 102 has lost the lock lease 134 as a visual and/or audible notification. Through execution of the instructions 122-126, the processor 110 may delay output of the notification until the processor 110 determines that the apparatus 102 has lost the lock lease 134. In one regard, by delaying output of the notification in this manner, the processor 110 may output a relatively smaller number of notifications as the processor 110 may not output the notification in instances in which the apparatus 102 acquires or reacquires the lock lease 134 following a prior failure to receive the reply from the server 104.

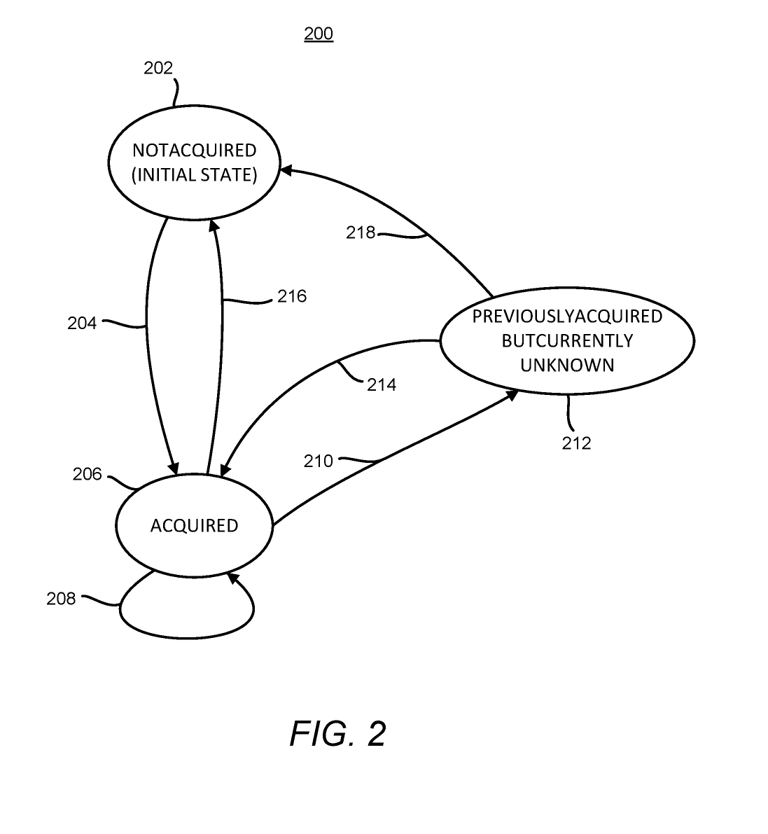

With reference now to FIG. 2, there is shown a diagram of an apparatus state machine 200, in accordance with an embodiment. The description of FIG. 2 is made with reference to the elements depicted in FIG. 1. Particularly, FIG. 2 depicts various states of the apparatus 102 with regard to the lock lease 134 on the external resource 140. As shown in FIG. 2, the apparatus 102 may be in an initial state 202, e.g., a NotAcquired state, in which the apparatus 102 does not have a lock lease 134 on the external resource 140. Following communication of a request for the lock lease 134 to the server 104, the apparatus 102 may acquire the lock lease 134 as indicated by the arrow 204. In other words, the apparatus 102 may acquire a distributed exclusive lock on the external resource 140 and may thus be in an Acquired state 206. By way of particular example, the apparatus 102 may acquire the exclusive lock, e.g., lock lease 134, when a user provides input to the apparatus 102 to open a particular application for editing. The apparatus 102 may acquire the lock lease 134 for a set period of time, in which the set period of time may be known to both the distributed lock service, e.g., the server 104, and to the apparatus 102. Once the lock lease 134 is acquired, the apparatus 102 may download and store a copy 132 of the external resource 140 locally, e.g., in the data store 114.

As indicated by the arrow 208, the processor 110 may run a task, e.g., a background task, that periodically attempts to renew the lock lease 134 before the lock lease 134 expires. The processor 110 may continue to run the task 208 for as long as the renewals are successful and the user is still editing the copy 132 of the external resource 140.

Due to network instabilities as well as other potential issues, the processor 110 may be unable to renew the lock lease 134 prior to expiration of the set period of time during which the lock lease 134 is in force. In addition, the processor 110 may determine that the lock lease 134 has expired based on a clock of the apparatus 102 and the known duration of the most recent lock lease 134, as indicated by the arrow 210. In this event, the apparatus 102 may enter into a PreviouslyAcquiredButCurrentlyUnkown state 212. In this state, the processor 110 may not know whether the lock lease 134 is available or if the server 104 has granted a lock lease to the external resource 140 to another client machine. The apparatus 102 may enter into the PreviouslyAcquiredButCurrentlyUnkown state 212 based on the processor 110 transmitting a request for renewal of the lock lease 134, the processor 110 failing to receive a reply to the request within a certain period of time, or the lock lease 134 expiring.

While in the PreviouslyAcquiredButCurrentlyUnkown state 212, the processor 110 may continue to run the background task to reacquire the lock lease 134. As such, when the network connection to the server 104 is again available, the processor 110 may succeed in reacquiring the lock lease 134 as indicated by the arrow 214. In addition, once the user has finished editing the copy 132 of the external resource 140 and saved the edits, the apparatus 102 may release the lock lease 134 as indicated by the arrow 216 so that other apparatuses or the apparatus 102 may acquire the lock lease 134 in the future. In this case, no user intervention may have been requested or required during the period of network instability that occurred between the operations indicated by the arrows 210 and 214.

According to examples of the present disclosure, users may be allowed to edit and continue to edit the copy 132 of the external resource 140 on the apparatus 102 while the apparatus 102 is either in the Acquired state 206 or in the PreviouslyAcquiredButCurrentlyUnkown state 212. However, attempts to save the copy 132 of the external resource 140 on the server 104 may be allowed while the apparatus 102 is in the Acquired state 206 but may not be allowed while the apparatus 102 is in the PreviouslyAcquiredButCurrentlyUnkown state 212.

While in the PreviouslyAcquiredButCurrentlyUnkown state 212, and after the network connection to the server 104 is again available, the user may be given the option to save the copy 132 of the external resource 140 on the server 104 with another file name. In this regard, the user may be given the option to perform a “Save As” operation on the copy 132 of the external resource 140 on the server 104. While saving the copy 132 on the server 140, a conflict might be detected (e.g., a different user may have saved an updated version of the external resource 140 while the apparatus 102 had been in the PreviouslyAcquiredButCurrentlyUnknown state 212). In this instance, the user may be given the choice of overwriting the other user's changes, “Saving As” a different name, or discarding the current user changes.

An informational message may be outputted to the user (e.g., via the output device 116) on the transition 210 from the Acquired state 206 to the PreviouslyAcquiredButCurrentlyUnkown state 212 to indicate that the user is allowed to continue to make edits on the copy 132, but that a save operation to the server 104 may be unavailable until the apparatus 102 comes back to the Acquired state 206. In addition, an informational message may be outputted to the user (e.g., via the output device 116) on the transition 214 from the PreviouslyAcquiredButCurrentlyUnkown state 212 to the Acquired state 206 to indicate that saves to the server 104 may be guaranteed to be in a valid state.

While in the PreviouslyAcquiredButCurrentlyUnkown state 212, and following the network connection to the server 104 being available again, the processor 110 may receive a reply from the server 104 indicating that the apparatus 102 has lost the lock lease 134 to the external resource 140. That is, for instance, the server 104 may send a reply to the apparatus 102 that indicates that the apparatus 102 has lost the lock lease 134 and that the lock lease 134 is still available. Alternatively, the reply may indicate that the apparatus 102 has lost the lock lease 134 and that another client machine has acquired the lock lease 134. In either of these scenarios, the apparatus 102 may enter the NotAcquired state 202, e.g., the state in which the apparatus 102 does not have a lock lease 134 to external resource 140.

Prior to and/or during the transition 218 from the PreviouslyAcquiredButCurrentlyUnkown state 212 to the NotAcquired state 202, the processor 110 may display a prompt dialog via the output device 116 to inform the user of the transition from the PreviouslyAcquiredButCurrentlyUnkown state 212 to the NotAcquired state 218. The prompt dialog may indicate that another user has taken ownership of the external resource 140, e.g., that another user has acquired a lock lease on the external resource 140. The prompt dialog may also indicate that it is no longer recommended to continue editing the copy 132 of the external resource 140. Moreover, the prompt dialog may give the user the option to save the copy 132 as another file on the server 104 or continue at their own risk, in which case the user may hope that the other user will not save their changes to the external resource 140.

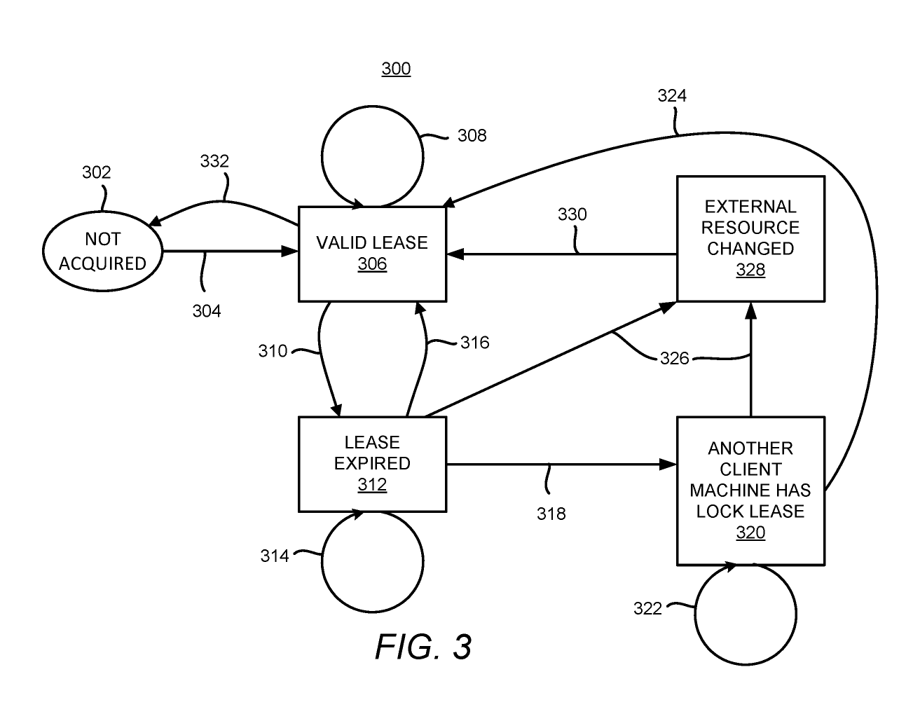

With reference now to FIG. 3, there is shown a process flow diagram 300 for management of a lock lease 134 to an external resource 140 in accordance with an embodiment. The description of FIG. 3 is made with reference to the elements depicted in FIG. 1. Initially, a user (UserA) may not currently have the lock lease 134 to the external resource 140 as indicated by block 302. In addition, the user may attempt to open an external resource 140, e.g., attempts to open an app, on the user's client machine, e.g., apparatus 102. This may result in the processor 110 of the apparatus 102 attempting to acquire a lock lease 134 to the external resource 140 from the server 104. If the attempt is successful, the apparatus 102 may acquire a lock lease 134 to the external resource 140 as indicated by the arrow 304 and block 306 and the user may have exclusive editing access to the external resource 140. In addition, a copy 132 of the external resource 140 may be stored locally on the apparatus 102 as discussed herein.

The processor 110 may schedule a task to renew the lock lease 134 before the lock lease 134 expires. In addition, the processor 110 may successfully renew the lock lease 134 as indicated by the arrow 308 to continue to have a valid lock lease 134 to the external resource 140 as indicated at block 306. The processor 110 may continue to attempt to renew the lock lease 134 on a periodic basis, e.g., prior to expiration of the lock lease 134 period.

However, if the renewal attempt is unsuccessful, for instance, due to connectivity issues (user is offline), a disruption in the network 106 occurs, or the like, the processor 110 may retry the renewal attempt. During or after the renewal attempts, the processor 110 may determine that the lock lease 134 has expired at block 312. Following the determination that the lock lease 134 has expired, the processor 110 may continue to attempt to renew the lock lease 134 as indicated by the arrow 314. The processor 110 may continue with the renewal attempts until the processor 110 determines that one of a number of conditions has been reached. For instance, the processor 110 may determine that an attempt to renew the lock lease 134 was successful as indicated by the arrow 316. In this instance, the apparatus 102 may have re-acquired the lock lease 134 as indicated at block 306 and the processor 110 may continue the renewal attempts as discussed above.

If the renewal attempts 314 fail, for instance, because another user (UserB) acquired a lock lease to the external resource 140 while the user (UserA) was offline or otherwise disconnected from the server 104 as indicated by the arrow 318, UserA may be notified that someone else is actively editing the external resource 140. In other words, the processor 110 may determine that another client machine has a lock lease on the external resource 140 as indicated at block 320. In addition, the processor 110 may notify UserA that the user may decide to keep their session or abandon their session with the copy 132 of the external resource 140.

The processor 110 may also schedule a recurring task to retry acquiring the lock lease 134 to the external resource 140 at regular time intervals (e.g., every 5 mins, every 10 mins, etc.). In addition, the processor 110 may attempt to acquire the lock lease 134 at the regular time intervals as indicated by the arrow 322 until the apparatus 102 is able to acquire an exclusive lock lease 134 to the external resource 140 (e.g., another user does not have an active lock lease to the external resource 140). If the retry succeeds, the apparatus 102 (e.g., UserA) may regain the exclusive lock lease 134 to the external resource 140 as indicated by the arrow 324.

As part of or in addition to the renewal attempts at 314 or 322, the processor 110 may perform a version check as indicated by the arrow 326. The processor 110 may perform the version check to determine whether the copy 132 of the external resource 140 on the apparatus 102 on which the user is still working is the latest version of the external resource 140. If the version check fails, which may be an indication that another user has changed the external resource 140 on the server 104 while the apparatus 102 was offline or otherwise disconnected from the server 104, the processor 110 may output a message indicating the version mismatch. That is, the processor 110 may determine that the external resource has been changed as indicated at block 328. In addition, the processor 110 may prompt a user to discard the changes that the user made to the copy 132 of the external resource 140 or force an overwrite of the external resource 140 on the server 104. The processor 110 may receive a user instruction to force an overwrite of the version of the external resource 140 with the version of the copy 132 on the apparatus 102 and the apparatus 102 may again acquire the lock lease 134 as indicated by the arrow 330. The processor 110 may alternatively receive a user instruction to discard the changes that the user made to the copy 132 of the external resource 140, in which case the apparatus 102 may not drop the lock lease 134 and may return to block 302.

If the apparatus 102 re-acquires the lock lease 134 and returns to block 306, the processor 110 may continue to attempt to renew the lock lease 134 until a user has completed editing the copy 132 of the external resource 140. Once the user has completed editing the copy 132 and has uploaded or overwritten the updated version of the external resource 140 on the server 104, the processor 110 may drop the lock lease 134 as indicated by the arrow 332. The apparatus 102 may thus return to block 302 at which the apparatus 102 does not have the lock lease 134. In addition, the apparatus 102 may return to block 302 in instances in which the lock lease 134 is overridden, for instance, the server 104 cancels the lock lease 134 with the apparatus 102 and grants the lock lease to another client machine.

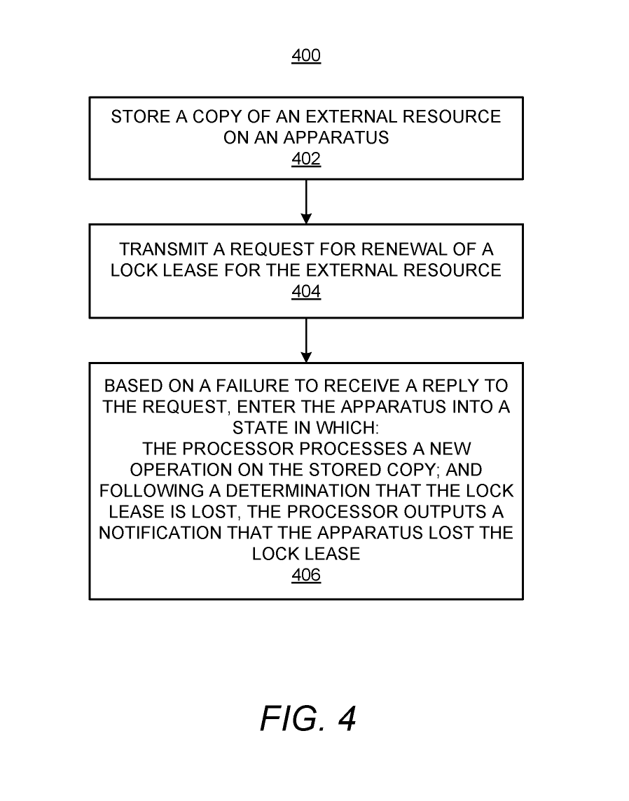

Turning now to FIG. 4, there is shown a flow diagram of a method 400 for managing a lock lease 134 for an external resource 140 in accordance with an embodiment. It should be apparent to those of ordinary skill in the art that the method 400 may represent a generalized illustration and that other operations may be added or existing operations may be removed, modified, or rearranged without departing from a scope of the method 400. The description of the method 400 is made with reference to the apparatus 102 and the server 104 illustrated in FIG. 1 for purposes of illustration. It should be understood that apparatuses having other configurations may be implemented to perform the method 400 without departing from a scope of the method 400.

At block 402, the processor 110 may execute the instructions 120 to store a copy 132 of an external resource 140 on the apparatus 102. The external resource 140 may be stored and/or hosted on a server 104. In addition, the processor 110 may initially access the external resource 140 via a network 106 in response to a receipt of a user instruction to store and/or execute the external resource 140. Prior to, during, or after the copy 132 of the external resource 140 is stored on the apparatus 102, e.g., in the data store 114 of the apparatus 102, the server 104 may grant the apparatus 110 an exclusive lock, e.g., a lock lease 134, for the external resource 140. The processor 110 may request the lock lease 134 by attempting to download a copy of the external resource 140 from the server 104. The server 104 may grant the lock lease if a lock lease to the external resource 140 is not currently acquired by another client machine. In any regard, the lock lease 134 may be set to expire after a predefined time period, and the processor 110 and the server 104 may both be aware of the predefined time period, which may begin to toll once the processor 110 has acquired the lock lease.

At block 404, the processor 110 may execute the instructions 124 to transmit a request for renewal of a lock lease 134 for the external resource 140. As discussed herein, the processor 110 may transmit the request for renewal of the lock lease 134 prior to expiration of the lock lease 134. The processor 110 may transmit the renewal request to the server 104 on which the external resource 140 is stored and/or hosted. In response to receipt of a reply granting the renewal, the processor 110 may reset a timer or a counter such that the processor 110 may transmit another renewal request prior to expiration of the current lock lease 134. According to examples, the processor 110 may set a background task to periodically renew the lock lease 134 prior to expiration of the predefined time period.

At block 406, the processor 110 may execute the instructions 126 to, based on a failure to receive a reply to the renewal request, enter the apparatus 102 into a certain state. While in the certain state, the processor 110 may process a new operation on the stored copy 132 of the external resource 140. In addition, the processor 110 may process an existing operation, e.g., an operation that the processor 110 was already processing and/or had in a process queue prior to the apparatus 100 entering into the certain state. In this regard, the processor 110 may continue to implement a user's instructions to edit the copy 132 of the external resource 140 while in the certain state. In addition, while in the certain state, following a determination that the lock lease 134 is lost, the processor 110 may output a notification that the apparatus 102 has lost the lock lease 134. In one regard, the processor 110 may not output the notification until the processor 110 determines that the lock lease 134 is lost. As discussed herein, by delaying the output of the notification, the processor 110 may operate under the optimistic belief that the lock lease 134 may be re-acquired.

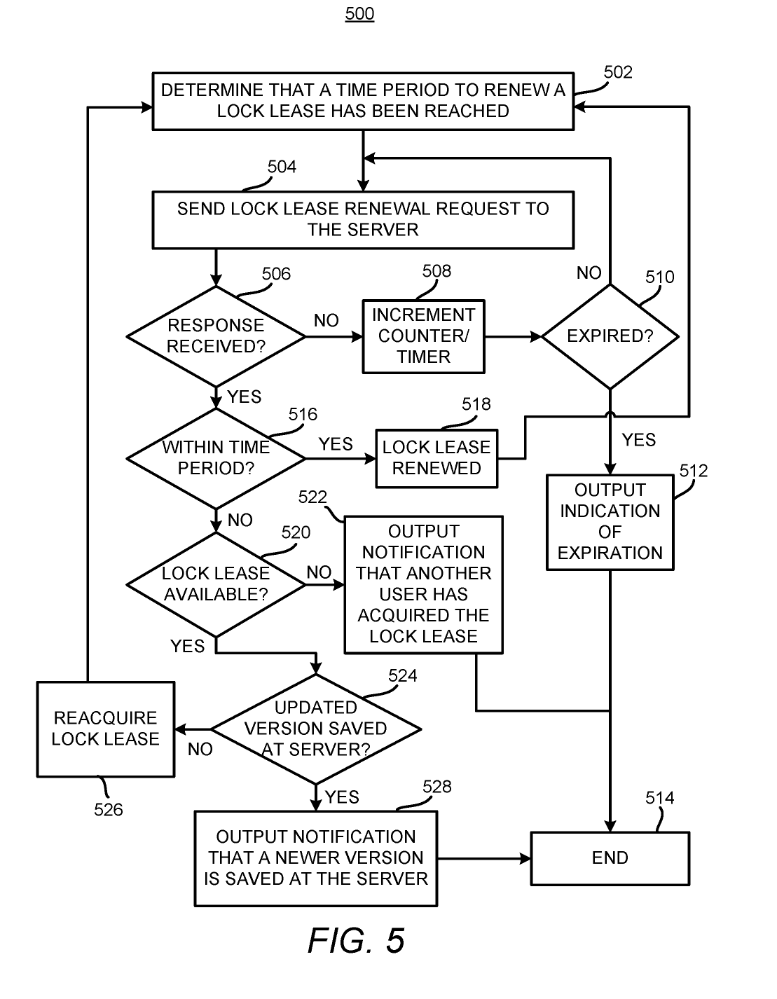

With reference now to FIG. 5, there is shown a flow diagram of a method 500 for managing renewal of a lock lease 134 for an external resource 140 on a server 104 in accordance with an embodiment. The processor 110 may execute the method 500 during or following execution of the method 400 depicted in FIG. 4. As such, for instance, the processor 110 may execute the method 500 following acquisition of the lock lease 134 for the external resource 140 and while the processor 110 is in the certain state discussed above with respect to block 406. The description of the method 500 is made with reference to the network environment 102 shown in FIG. 1 and the process flow diagram 300 shown in FIG. 3 for purposes of illustration.

At block 502, the processor 110 may determine that a time period to renew a lock lease 134 for the external resource 140 has been reached. The time period to renew the lock lease 134 may be set to be reached prior to the time period of the lock lease 134 expiring. By way of example, the time period to renew the lock lease 134 may be set to provide the processor 110 with sufficient time to submit a renewal request and for the renewal request to be approved prior to expiration of the lock lease 134.

At block 504, the processor 110 may send a lock lease renewal request to the server 104 that controls the distribution of the lock lease 134 among multiple client machines. At block 506, the processor 110 may determine whether a response to the lock lease renewal request from the server 104 has been received. The processor 110 may not receive a response from the server 104, for instance, when there is a network error or disruption. Based on a determination that a response to the lock lease renewal request was not received, the processor 110 may increment a counter and/or a timer as indicated at block 508. In addition, at block 510, the processor 110 may determine whether the counter and/or the timer has expired, e.g., reached a predetermined count or a predetermined time since the processor 110 sent the lock lease renewal request.

Based on a determination that the counter and/or the timer has not expired at block 510, the processor 110 may send another lock lease renewal request at block 504. The processor 110 may repeat blocks 504-510 so long as the processor 110 continues to fail to receive a response from the server 104 at block 506 and the counter and/or timer has not expired at block 510. However, based on a determination at block 510 that the counter and/or timer has expired, at block 512, the processor 110 may output an indication that the counter and/or timer has expired without a response from the server 104 having been received. The processor 110 may output the notification via the output device 116 such that a user may determine the cause of the failure to receive the response from the server 104. In addition, the method 500 may end as indicated at block 514.

Following block 514, the processor 110 may continue to send lock lease renewal requests to the server 104 as discussed above with respect to FIG. 3. That is, for instance, as the lock lease 134 may have expired following block 514, after the processor 110 receives a response from the server 104, the processor 110 may determine that the lock lease 134 is available and that the external resource 140 has not been changed. In this case, the apparatus 102 may reacquire the lock lease as indicated by the arrow 316. In another example, the processor 110 may determine that another client machine has acquired the lock lease (block 320) and the processor 110 may force the server 104 to drop the lock lease to the other client machine and to provide the apparatus 102 with the lock lease 134 as indicated by the arrow 324. In a further example, the processor 110 may determine that another client machine has changed the external resource (block 328). In this example, the processor 110 may force an overwrite of the changed external resource and may reacquire the lock lease 134 for the external resource 140.

With reference back to FIG. 5, at block 506, based on a determination that a response is received from the server 104, the processor 110 may determine whether the processor 110 received the response from the server 104 prior to or after expiration of the lock lease 134 time period. In instances in which the processor 110 receives the response from the server 104 prior to expiration of the lock lease 134 time period, the processor 110 may determine that the lock lease 134 has been renewed at block 518. In addition, following block 518, the processor 110 may repeat the method 500 beginning at block 502.

However, in instances in which the processor 110 receives the response following expiration of the lock lease 134 time period, the processor 110 may determine whether the lock lease 134 is available at block 520. Based on a determination that the lock lease 134 and is not available, the processor 110 may output a notification that another user (or equivalently, another client machine) has acquired the lock lease for the external resource 140. The processor 110 may output the notification via the output device 116. In some examples, the method 500 may end following block 522. In other examples, the processor 110 may continue to send lock lease renewal requests to the server 104 as discussed above with respect to FIG. 3.

Based on a determination that the lock lease for the external resource 140 is available, at block 524, the processor 110 may request for version information of the external resource 140 from the server 104 and may determine whether an updated version (e.g., a newer version) of the external resource 140 has been saved at the server 104. Based on a determination that an updated version of the external resource 140 has not been saved to the server 104, the processor 110 may reacquire the lock lease 134 as indicated at block 526. In addition, following block 526, the processor 110 may repeat the method 500 beginning at block 502.

However, based on a determination that an updated version of the external resource 140 has been saved to the server 140, the processor 110 may output a notification that an updated version of the external resource 140 is saved at the server 104. The processor 110 may output the notification via the output device 116. In this regard, the processor 110 may inform the user of the apparatus 102 that the copy 132 of the external resource 140 saved in the data store 114 may not be the latest version of the external resource 140. In some examples, the method 500 may end following block 528. In other examples, and as discussed above with respect to FIG. 3, the processor 110 may prompt a user to discard the changes that the user made to the copy 132 of the external resource 140 or force an overwrite of the external resource 140 on the server 104. The processor 110 may receive a user instruction to force an overwrite of the version of the external resource 140 with the version of the copy 132 on the apparatus 102, which the processor 110 may execute, and the apparatus 102 may again acquire the lock lease 134 as indicated by the arrow 330. The processor 110 may alternatively receive a user instruction to discard the changes that the user made to the copy 132 of the external resource 140, in which case the apparatus 102 may not drop the lock lease 134 and may return to block 302.

Some or all of the operations set forth in the methods 400 and 500 may be contained as utilities, programs, or subprograms, in any desired computer accessible medium. In addition, the methods 400 and 500 may be embodied by computer programs, which may exist in a variety of forms both active and inactive. For example, they may exist as machine readable instructions, including source code, object code, executable code or other formats. Any of the above may be embodied on a non-transitory computer readable storage medium.

Examples of non-transitory computer readable storage media include computer system RAM, ROM, EPROM, EEPROM, and magnetic or optical disks or tapes. It is therefore to be understood that any electronic device capable of executing the above-described functions may perform those functions enumerated above.

Although described specifically throughout the entirety of the instant disclosure, representative examples of the present disclosure have utility over a wide range of applications, and the above discussion is not intended and should not be construed to be limiting, but is offered as an illustrative discussion of aspects of the disclosure.

What has been described and illustrated herein is an example of the disclosure along with some of its variations. The terms, descriptions and figures used herein are set forth by way of illustration only and are not meant as limitations. Many variations are possible within the spirit and scope of the disclosure, which is intended to be defined by the following claims—and their equivalents—in which all terms are meant in their broadest reasonable sense unless otherwise indicated.

What is claimed is:

1. An apparatus comprising:
a processor; and
a memory on which is stored machine readable instructions that are to cause the processor to:
store a copy of an external resource on the apparatus;
transmit a request for renewal of a lock lease for the external resource; and
based on a failure to receive a reply to the renewal request, enter the apparatus into a state in which:
the processor processes a new operation on the stored copy of the external resource; and
following a determination that the lock lease is lost, the processor outputs a notification that the apparatus lost the lock lease.

2. The apparatus according to claim 1, further comprising:
machine readable instructions to cause the processor to:
request an additional lock lease renewal for the external resource until:
a timer or counter expires; or
the lock lease is renewed.

3. The apparatus according to claim 1, further comprising:
machine readable instructions to cause the processor to:
based on the lock lease being available, request version information of the external resource from a server.

4. The apparatus according to claim 3, further comprising:
machine readable instructions to cause the processor to:
based on a determination, from the version information, that an updated version of the external resource is available on the server, output an instruction to save the copy of the external resource as a new resource on the server.

5. The apparatus according to claim 3, further comprising:
machine readable instructions to cause the processor to:
based on a determination, from the version information, that an updated version of the external resource is available on the server, output an instruction to overwrite the updated version of the external resource on the server with a current version of the copy of the external resource stored on the apparatus.

6. The apparatus according to claim 1, wherein to determine that the apparatus lost the lock lease, the machine readable instructions are to cause the processor to determine that an indication that the lock lease is unavailable is received.

7. The apparatus according to claim 6, further comprising:
machine readable instructions to cause the processor to:
based on receipt of the indication that the lock lease is unavailable, transmit an override to re-acquire the lock lease.

8. The apparatus according to claim 1, wherein to determine that the apparatus lost the lock lease, the machine readable instructions are to cause the processor to:
determine that an updated version of the external resource is available outside of the apparatus; and
output a notification to indicate that the updated version of the external resource is available.

9. The apparatus according to claim 1, wherein the failure to receive the reply to the renewal request is due to a loss in a network connection of the apparatus, the apparatus further comprising:
machine readable instructions to cause the processor to at least one of:
following reestablishment of the network connection, request renewal of the lock lease; or
based on a determination that a version of the external resource outside of the apparatus is unchanged from a version of the copy of the external resource stored on the apparatus, one of:
request renewal of the lock lease; or
request an override to re-acquire the lock lease.

10. A computer-implemented method comprising:
storing, by a processor, a copy of an external resource on an apparatus;
transmitting, by the processor, a request for renewal of a lock lease for the external resource;
based on a failure by the processor to receive a reply to the renewal request, entering, by the processor, the apparatus into a certain state wherein:
the processor processes a new operation on the stored copy of the external resource; and
following a determination that the lock lease is lost, the processor outputs a notification that the apparatus lost the lock lease.

11. The method of claim 10, further comprising:
requesting an additional lock lease renewal for the external resource;
determining that a timer or a counter expired; or
determining that the lock lease is renewed.

12. The method of claim 10, further comprising:
based on a determination that the lock lease is available, requesting version information of the external resource from a server; and
determining, from the version information, that an updated version of the external resource is available on the server.

13. The method of claim 12, further comprising:
based on a determination that an updated version of the external resource is available, at least one of:
outputting an instruction to save the copy of the external resource on the apparatus as a new resource on the server; or
outputting an instruction to overwrite the updated version of the external resource on the server with a current version of the copy of the external resource stored on the apparatus.

14. The method of claim 10, further comprising:
receiving an indication that an updated version of the external resource is available outside of the apparatus; and
outputting a notification to indicate that the updated version of the external resource is available.

15. The method of claim 10, wherein the failure to receive the reply to the renewal request is due to a loss in a network connection of the apparatus, the method further comprising:
following reestablishment of the network connection, requesting renewal of the lock lease for the external resource.

16. The method of claim 10, further comprising:
based on a determination that a version of the external resource outside of the apparatus is unchanged from a version of the copy of the external resource stored on the apparatus, one of:
requesting renewal of the lock lease; or
requesting an override to re-acquire the lock lease.

17. A non-transitory computer readable medium on which is stored machine readable instructions that when executed by a processor, cause the processor to:
store a copy of an external resource on an apparatus;
transmit a request for renewal of a lock lease for the external resource;
based on a failure to receive a reply to the renewal request, enter the apparatus into a state in which:
the processor processes a new operation on the stored copy of the external resource; and
following a determination that the lock lease is lost, the processor outputs a notification that the apparatus lost the lock lease.

18. The non-transitory computer readable medium of claim 17, wherein the instructions are to cause the processor to:
request an additional lock lease renewal for the external resource until:
a timer or counter expires; or
the lock lease is renewed.

19. The non-transitory computer readable medium of claim 17, wherein the instructions are to cause the processor to:
based on a determination that the lock lease is renewed, request version information of the external resource from a server; and
determine, from the version information, that an updated version of the external resource is available on the server;
based on a determination that an updated version of the external resource is available on the server, at least one of:
output an instruction to save the copy of the external resource on the apparatus as a new resource on the server; or
output an instruction to overwrite the updated version of the external resource on the server with a current version of the copy of the external resource stored on the apparatus.

20. The non-transitory computer readable medium of claim 17, wherein the failure to receive the reply to the renewal request is due to a loss in a network connection of the apparatus, and wherein the instructions are to cause the processor to at least one of:
following reestablishment of the network connection, request renewal of the lock lease for the external resource; or
in response to a determination that a version of the external resource outside of the apparatus is unchanged from a version of the external resource stored on the apparatus, one of:
request renewal of the lock lease; or
request an override to re-acquire the lock lease.
